(19) United States
(12) Patent Application Publication
(10) Pub. No.: US 2007/0043200 A1
(43) Pub. Date: Feb. 22, 2007

(54) Use of an amorphous polyester as a polymer base for masticatory substances

(75) Inventors: Motonori Yamamoto, Mannheim (DE); Helmut Mach, Heidelberg (DE); Margit Hiller, Karlstadt (DE); Hans Peter Rath, Grunstadt (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF AKTIENGESELLSCHAFT, LUDWIGSHAFEN (DE)

(21) Appl. No.: 10/554,740

(22) PCT Filed: Apr. 28, 2004
(86) PCT No.: PCT/EP04/04484

§ 371 Date: Oct. 28, 2005

(30) Foreign Application Priority Data
Apr. 29, 2003 (DE) 103 19 315.4

(51) Int. Cl. C08G 63/02

(52) U.S. Cl. 528/272

(57) ABSTRACT

The use is described of an amorphous polyester as polymer base for gum bases. The application also relates to gum bases comprising such polyesters.

The present invention relates to the use of an amorphous polyester as polymer base for gum bases. In addition, the application relates to gum bases which comprise such polyesters.

Conventional gum bases are based on synthetic thermoplastics, such as polyvinyl ethyl ether, polyvinyl isobutyl ether, polyisobutene, isoprene-isobutene copolymers (butyl rubber), styrene-butadiene copolymers (SBR rubber) and polyvinyl acetate (PVA). Disadvantages with these polymers are their stickiness and poor biodegradability. Heedlessly discarded chewing gums are an ever-present irritation, since, once they are stuck to a surface, they may generally be removed only with great difficulty. Also, their decomposition by environmental factors, such as rain, sunlight, mechanical abrasion and microbial degradation, is so slow that the problem of their removal is not solved inherently.

U.S. Pat. No. 6,013,287 does describe a chewing gum base which is based on an endgroup-capped polyester and is said not to be very sticky. The alcohol component of the polyester is selected from glycerol, propylene glycol and 1,3-butanediol and the acid component is selected from fumaric acid, adipic acid, malic acid, succinic acid and tartaric acid. The polyester endgroups are capped with a monofunctional alcohol or a monocarboxylic acid. However, it is a disadvantage that such polyesters are virtually not degraded under customary environmental influences, in particular by sunlight.

EP-A 0711506 describes a biodegradable chewing gum which, in the gum base, comprises a biodegradable polyester or a biodegradable polycarbonate. The polyester or polycarbonate is based on condensed cyclic esters or carbonates, such as lactide, glycolide, δ-valerolactone, β-propiolactone, γ-caprolactone and trimethyl carbonate. However, a disadvantage with such polyesters and polycarbonates is that they are hardly broken down by UV light. Furthermore, these polyesters have a low stability to hydrolysis, so that the chewing gum rapidly loses its taste properties and tactile properties (perception of chewing).

It is an object of the present invention, therefore: to provide a polymer base for gum bases which is not sticky and not only is biodegradable but also can be broken down by UV light. Furthermore, the polymer base should at the same time exhibit good stability to hydrolysis.

We have found that this object is achieved by an amorphous polyester which comprises as repeating units in condensed form
a) at least one aromatic dicarboxylic acid,
b) at least one aliphatic dicarboxylic acid and
c) at least one aliphatic diol which has at least one branching point, a saturated cyclic partial structure and/or at least one ether group.

The invention thus relates to the use of such a polyester as polymer base for gum bases, and also to gum bases which comprise such a polyester.

For the purposes of the present invention, “amorphous” means polyesters which contain less than 5% by weight, preferably less than 2% by weight, of crystalline fractions, based on the total weight of the polyester. In particular, the proportion of crystalline constituents (where present at all) is below the customary limits of detection. For the purposes of the present invention, crystalline constituents are those which, during differential scanning calorimetry (DSC), exhibit melting and crystallization peaks (endothermal phase transition), Conversely, accordingly, amorphous polyesters are those which in DSC measurements have no measurable melting peaks or crystallization peaks. The DSC measurement for determining the amorphous state of the polyester is based on the following method: an Exstet DSC 6200R from Seiko is used. From 10 to 15 mg of the sample under test is heated under a nitrogen atmosphere at a heating rate of 20° C./min from −100° C. to 200° C. and observations are made as to whether melting peaks occur. The sample is then immediately cooled at a cooling rate of 20° C./min from 200° C. to −100° C. and observations are made as to whether crystallization peaks occur. The reference used is a corresponding blank sample crucible.

The polyesters used according to the invention are biodegradable. Biodegradability according to DIN V 54900 means that the polyesters break down under environmental influences in a reasonable and detectable time period. The breakdown can be by hydrolysis and/or oxidation and is predominantly caused by the action of microorganisms, such as bacteria, yeasts, fungi and algae. The biodegradability may be determined, for example, by mixing polyester with compost and storing it for a defined time. In accordance with ASTM D 5338, ASTM D 6400, EN 13432 and DIN V 54900, CO₂-free air is passed, for example, through matured compost during the composting process and this is subjected to a defined temperature program. In this case the biodegradability is defined from the ratio of net CO₂ release of the sample (after deducting the CO₂ release by the compost without sample) to the maximum CO₂ release of the sample (calculated from the carbon content of the sample). Biodegradable polyesters generally, even after only a few days of composting, exhibit marked signs of breakdown, such as fungal growth, cracking and pitting.

The biodegradability may also be determined by incubating the polyester with a defined amount of a suitable enzyme at a defined temperature for a fixed time period and then determining the concentration of the organic breakdown products dissolved in the incubation medium. For example, in a similar manner to Y. Tokiwa et al., American Chemical Society Symposium 1990, Chapter 12, “Biodegradation of Synthetic Polymers Containing Ester Bonds”. The polyester can be incubated with a predetermined amount of a lipase from, for example, Rhizopus arrhizus, Rhizopus delemar, Achromobacter sp. or Candida cylindracea for several hours at from 30 to 37° C., followed by measurement of the dissolved organic carbon (DOC) value of the reaction mixture freed from insoluble constituents. For the purposes of the present invention, biodegradable means polyesters which, after the enzymatic treatment with a lipase from Rhizopus arrhizus at 35° C., give, after 16 h, a DOC value which is at least 10 times higher than that of the same polyester which was not treated with the enzyme.

The polyesters used according to the invention are also broken down, in particular, by UV light, that is to say by sunlight, i.e., the polyesters disintegrate in a reasonable and detectable time period, the breakdown essentially being caused by sunlight. The UV degradability may be determined, for example, by irradiating the polyester with artificial UV light of a defined radiant intensity for a defined period and measuring the changes in the polyester. For example, the polyesters are irradiated with a wavelength of from 300 to 800 nm and a power of 765 W/m² for 8 weeks and their viscosity number is determined regularly, for example every week. Polyesters which can be broken down by UV light generally exhibit, even after only a few days, marked changes, in particular a marked decrease in viscosity number. For the purposes of the present invention, polyesters which can be broken down by UV light are those whose viscosity number decreases by at least 50% after irradiation for 3 weeks.

The aromatic dicarboxylic acid a) contains two carboxyl groups which are bound to one aromatic system. Preferably, the aromatic system is a carboaromatic, such as phenyl or naphthyl. In the case of polynuclear aromatics, the two carboxyl groups can be bound to the same ring or different rings. The aromatic system can also have one or more alkyl groups, for example methyl groups. The aromatic dicarboxylic acid is generally selected from aromatic dicarboxylic acids having from 8 to 12 carbons, such as phthalic acid, isophthalic acid, terephthalic acid, 1,5- and 2,6-naphthalenedicarboxylic acid. Preferred aromatic dicarboxylic acids are terephthalic acid, isophthalic acid and phthalic acid and mixtures thereof. In particular, the aromatic dicarboxylic acid is terephthalic acid or a mixture of aromatic dicarboxylic acids which comprises at least 80% by weight, preferably at least 90% by weight, and in particular at least 95% by weight, of terephthalic acid, based on the total weight of the mixture, and at least one of the abovementioned aromatic C₈-C₁₂ dicarboxylic acids.

The aliphatic dicarboxylic acid b) is generally selected from aliphatic dicarboxylic acids having from 4 to 12 carbons, such as succinic acid, glutaric acid, 2-methylglutaric acid, 3-methylglutaric acid, 2,2-dimethylglutaric acid, adipic acid, pimelic acid, suberic acid, azelaic acid and sebacic acid, higher homologues and stereoisomers and mixtures thereof. Preferred aliphatic dicarboxylic acids are succinic acid, glutaric acid, adipic acid, pimelic acid, azelaic acid and sebacic acid and mixtures thereof. In particular, the aliphatic C₄-C₁₂ dicarboxylic acid is adipic acid or a mixture of aliphatic dicarboxylic acids which contains at least 80% by weight, preferably at least 90% by weight, and in particular at least 95% by weight of adipic acid, based on the total weight of the mixture, and at least one of the abovementioned aliphatic C₄-C₁₂ dicarboxylic acids.

The molar ratio of aromatic dicarboxylic acid a) to aliphatic dicarboxylic acid b) is preferably from 1:4 to 2:1, particularly preferably from 1:2 to 3:2, and in particular from 2:3 to 1:1.

Aliphatic diols c) which can be used are in principle branched aliphatic diols, those having a saturated cyclic partial structure and/or at least one ether group. The aliphatic diol is preferably selected from 2,2-dimethylpropane-1,3-diol (neopentyl glycol), diethylene glycol, triethylene glycol, tetraethylene glycol, pentaethylene glycol, hexaethylene glycol, cyclohexanedimethanol and also mixtures thereof, and, particularly preferably, from neopentyl glycol, diethylene glycol, triethylene glycol and mixtures thereof.

Furthermore, the polyester can contain up to 20% by weight, preferably up to 10% by weight, and in particular up to 5% by weight, of a diol different from c), in condensed form. Examples of suitable diols are unbranched aliphatic C₂-C₁₂ diols, such as ethylene glycol, 1,3-propanediol, 1,4-butanediol, 1,5-pentanediol, 1,6-hexanediol and the like. The percentages are based on the total amount of diols c) and the abovementioned diols different from c). Preferably, however, the polyester does not contain any such diol.

Preferably, the inventively used polyester additionally contains, as repeating unit, in condensed form, at least one compound d) having at least three groups capable of ester formation.

Such compounds d), which are also called branchers, preferably contain from 3 to 10 functional groups, particularly preferably from 3 to 6 functional groups, which are capable of forming ester bonds. In particular, these groups are hydroxyl groups and carboxyl groups. Particularly preferred branchers d) therefore contain from 3 to 6 hydroxyl groups and/or carboxyl groups.

Preferably, in this case, these compounds are selected from tartaric acid, citric acid, malic acid, trimethylolpropane, trimethylolethane, pentaerythritol, polyethertriols, glycerol, trimesic acid, trimellitic acid, pyromellitic acid and hydroxyisophthalic acid. A particularly preferred brancher d) is glycerol.

The inventively used polyester contains the brancher d) in an amount of preferably from 0.1 to 5% by weight, particularly preferably from 0.5 to 3% by weight, and in particular from 1 to 1.5% by weight, based on the total weight of the polyester-forming constituents.

Furthermore, the inventively used polyester can contain one or more chain extenders in condensed form. Suitable chain extenders are, in particular, isocyanates, divinyl ethers and bisoxazolines.

Suitable isocyanates are aromatic or aliphatic diisocyanates and higher-functional isocyanates. Examples of suitable isocyanates are
aromatic diisocyanates, such as 2,4-toluylene diisocyanate, 2,6-toluylene diisocyanate, 2,2′-diphenylmethane diisocyanate, 2,4′-diphenylmethane diisocyanate, 4,4′-diphenylmethane diisocyanate, 1,5-naphthylene diisocyanate and xylylene diisocyanate, with 2,2′-, 2,4′- and 4,4′-diphenylmethane diisocyanate being preferred. Suitable substances are also mixtures of these isocyanates. A preferred higher-functional isocyanate is the trinuclear aromatic trilsocyanate tri(4-isocyanatophenyl)methane. The polynuclear aromatic isocyanates are produced, for example, in the preparation of mononuclear or binuclear diisocyanates.
aliphatic diisocyanates, in particular linear or branched alkylene diisocyanates or cycloalkylene diisocyanates having from 2 to 20, preferably from 3 to 12, carbons, such as 1,6-hexamethylene diisocyanate, isophorone diisocyanate and methylenebis(4-isocyanatocyclohexane). Preference is given here to 1,6-hexamethylene diisocyanate and isophorone diisocyanate.
Isocyanurates, in particular aliphatic isocyanurates which are derived from alkylene diisocyanates or cycloalkylene diisocyanates having from 2 to 20 carbons, preferably having from 3 to 12 carbons, such as isophorone diisocyanate or methylenebis(4-isocyanatocyclohexane), for example isocyanurates which are derived from n-hexamethylene diisocyanate, in particular cyclic trimers, pentomers or higher oligomers of the n-hexamethylene diisocyanate.

Suitable divinyl ethers are all customary and commercially available divinyl ethers. Preferred divinyl ethers are 1,4-butanediol divinyl ether, 1,6-hexanediol divinyl ether and 1,4-cyclohexanedimethanol divinyl ether, or mixtures thereof.

Suitable bisoxazolines are 2,2′-bisoxazolines of the formula

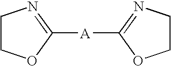

where A is a single bond, a C₂-C₄-alkylene bridge, such as 1,2-ethylene, 1,2- or 1,3-propylene, 1,2-, 1,3-, 1,4- or 2,3-butylene, or phenylene, in condensed form.

The bisoxazolines are obtainable, for example, by the process described in Angew. Chem. Int. Ed., Volume 11 (1972), pp. 287-288.

Preferred bisoxazolines are 2,2′-bis(2-oxazoline), bis(2-oxazolinyl)methane, 1,2-bis(2-oxazolinyl)ethane, 1,3-bis(2-oxazolinyl)propane, 1,4-bis(2-oxazolinyl)butane, 1,4-bis(2-oxazolinyl)benzene, 1,3-bis(2-oxazolinyl)benzene and 1,2-bis(2-oxazolinyl)benzene.

If the inventively used polyester does contain such chain extenders, these are present in an amount of preferably from 0.01 to 5% by weight, in particular preferably from 0.05 to 4% by weight, based on the total weight of the polyester-forming components a), b) and c).

Preferably, the polyester contains no chain extender, that is to say less than 0.1% by weight, based on the total weight of the polyester.

Preferably, the inventively used polyester is made up of at least 95% by weight, particularly preferably at least 96% by weight, and in particular at least 98% by weight, for example from 98 to 99.9% by weight, of the components a), b), c) and d).

The inventively used polyester preferably has a glass transition temperature T_{g} of from −60 to 0° C., particularly preferably from −50° C. to 0° C. The T_{g} values specified were determined by DSC measurements. The DSC measurements were carried out in accordance with conventional processes of the prior art which are known to those skilled in the art.

Furthermore, the inventively used polyester is characterized by a viscosity number in the range generally from 30 to 250 ml/g, preferably from 50 to 200 ml/g, and in particular from 80 to 150 ml/g (measured in o-dichlorobenzene/phenol (weight ratio 50:50) at a concentration of 0.5% by weight polyester at a temperature of 25° C., in accordance with EN ISO 1628-1).

The inventively used polyester is prepared by methods known per se, as are described, for example, in Sorensen and Campbell, “Preparative Methods of Polymer Chemistry”, Interscience Publishers, Inc., New York, 1961, pages 111 to 127; Encycl., of Polym. Science and Eng., Vol. 12, 2nd Edition John Wiley & Sons, 1988, pages 1 to 75, Kunststoff-Handbuch, Vol. 3/1, Carl Hanser Verlag, Munich, 1992, pages 15 to 32; WO 92/13019; EP-A 568593; EP-A 565235; EP-A 28687; EP-A 792309 and EP-A 792310, which are hereby incorporated completely by reference.

The dicarboxylic acids a) and b) can be used in the preparation process either in the form of the acid or as ester-forming derivatives. Ester-forming derivatives are, for example, the anhydrides of these acids or their esters, for example with C₁-C₆ alkanols, such as methanol, ethanol, n-propanol, isopropanol, n-butanol, sec-butanol, isobutanol, tert-butanol, n-pentanol, isopentanol or n-hexanol. The same applies to component d) if this contains carboxyl groups.

Depending on whether an excess of acid endgroups or hydroxyl endgroups is desired, either the acid components a) or b) or the diol component c) can be used in excess. However, preferably, the acid components a) and b) and the diol component c) are used in a molar ratio of [a)+b)]:c)=from 1:1 to 1:2.5, particularly preferably from 1:1.1 to 1:1.5.

Only as an example is mention made of the reaction of the polyester-forming components first at temperatures in the range from 160 to 230° C. in the melt at atmospheric pressure, preferably under an inert gas atmosphere, and then, to complete the polycondensation up to the desired molecular weight, at a temperature of from 180 to 260° C. and a reduced pressure (see Tsai et al., Polymer 1990, 31, 1589).

The invention further relates to a gum base comprising at least one as-above-defined polyester and at least one further additive.

Gum base is generally the term used for the water-insoluble indigestible chewing gum component which becomes plastic on chewing (see Römpp Chemie-Lexikon [Römpp's Chemistry Lexicon], 9th Edition, Georg Thieme Verlag, Stuttgart, N.Y., p. 2181). Customarily, the gum base, in addition to the polymer base, contains other additives, such as resins, waxes, fats and oils, which generally act as plasticizers and emulsifiers and enhance the tactile properties (chewability, mouth feel), and in addition inorganic fillers, coloring agent, bleaches and antioxidants.

Preferably, the gum base contains the polyester in an amount of from 20 to 90% by weight, particularly preferably from 20 to 70% by weight, and in particular from 20 to 50% by weight, based on the total weight of the gum base.

Suitable resins are, for example, colophony derivatives, such as pentaerythritol esters of colophony, hydrogenated or partially hydrogenated colophony and glycerol esters of colophony, hydrogenated, partially hydrogenated, partially dimerized or polymerized colophony, and in addition terpene resins, such as polymerized α- or β-pinene. If the gum base contains resins, these are generally present in an amount of from 5 to 30% by weight, based on the total weight of the gum base.

Suitable waxes are, for example, plant waxes, such as candelilla wax and carnauba wax, animal waxes, such as beeswax and lanolin, and petrochemical waxes, such as paraffin waxes and microwaxes (microcrystalline waxes). If the gum base contains waxes, these are generally present in an amount of from 1 to 15% by weight, based on the total weight of the gum base.

Suitable fats and oils are, for example, tallow, hydrogenated tallow, hydrogenated and partially hydrogenated vegetable oils, such as soybean oil, sunflower oil, corn oil, rapeseed oil, peanut oil, palm oil and cottonseed oil, cocoa butter, glycerol monostearate, glycerol triacetate, lecithin, fatty acid mono-, di- and triglycerides, acetylated monoglycerides, fatty acids such as stearic acid, palmitic acid, oleic acid and linoleic acid, and also mixtures thereof. If the gum base contains fats and oils, these are generally present in an amount of from 5 to 30% by weight, based on the total weight of the gum base.

Suitable fillers are, for example, magnesium carbonate and calcium carbonate, ground limestone, talc, silicates, such as magnesium silicates and aluminum silicates, clay, alumina, titanium oxide, mono-, di- and tricalcium phosphate, cellulose polymers and mixtures thereof. If the gum base contains fillers, these are generally present in an amount of from 5 to 30% by weight, based on the total weight of the gum base.

The term “ucoloring agent” as used here and in the following comprises natural dyes, nature-identical dyes, synthetic dyes, as well as pigments. Suitable coloring agents and bleaches are in particular those which are suitable for food use, for example fruit and vegetable extracts, titanium dioxide and mixtures thereof. If the gum base contains coloring agents and bleaches, these are generally present in an amount of from 0.01 to 1% by weight, based on the total weight of the gum base.

Suitable antioxidants are those which are suitable for food use, for example butylated hydroxyanisole, butylated hydroxytoluene and propyl gallate. If the gum base contains antioxidants, these are generally present in an amount of from 0.01 to 1% by weight, based on the total weight of the gum base.

In addition, the gum base can contain natural elastomers, such as chicle, jelutong, lechi caspi, gutta hang kang, gutta soh, gutta siak, massaranduba balata, massaranduba chocolate and the like. If the gum base contains natural elastomers, these are generally present in an amount of from 1 to 30% by weight, based on the total weight of the gum base.

In a specific embodiment, the gum base contains no components of animal origin, in particular no animal waxes, fats or oils, so that it complies with the requirements for kosher foods.

The inventive gum base is available by conventional processes of the prior art, for example by intimate mixing of the components.

Finally, the present invention relates to a chewing gum comprising a gum base defined as above and also other additive components, in particular at least one sweetener and at least one flavoring.

Customarily, a chewing gum consists of a water-insoluble gum base, a water-soluble component and flavorings (see U.S. Pat. No. 6,013,287 and EP-A 0711506).

The water-soluble component generally comprises plasticizers and sweeteners. The plasticizers are added to the gum base in order to enhance chewability and the mouth feel of the chewing gum.

Examples of suitable plasticizers are glycerol, lecithin and mixtures thereof. Plasticizers and emulsifiers which can be used are, in addition, sorbitol, hydrogenated starch hydrolysates, corn syrup and mixtures thereof.

Sweeteners comprise not only sugars, but also sugar substitutes and intensive sweeteners.

Suitable sugars are, for example, sucrose, dextrose, maltose, dextrin, invert sugar, glucose, fructose, galactose and the like and also mixtures thereof.

Examples of suitable sugar substitutes are sugar alcohols, such as sorbitol, mannitol, Isomalt (Palatinit), xylitol, hydrogenated starch hydrolysates, maltitol, lactitol and the like and also mixtures thereof.

(Synthetic) intensive sweeteners are, for example, Sucralose, aspartame, acesulfame salts, alitame, saccharine and salts thereof, cyclamates, glycyrrhizin, dihydrochalcones, thaumatin, monellin, dulcin, stevioside and the like.

Suitable flavorings are generally water-insoluble and comprise vegetable oils and fruit oils, such as citrus oil, fruit essences, peppermint oil, spearmint oil, other mint oils, clove oil, aniseed oil and the like. Artificial flavorings can also be used.

Preferably, the gum base is present in the chewing gum in an amount of from 5 to 95% by weight, particularly preferably from 10 to 50% by weight, and in particular from 20 to 35% by weight, based on the total weight of the chewing gum.

Preferably, the water-soluble components are present in the chewing gum in an amount of from 3 to 94.9% by weight, particularly preferably from 49 to 89.5% by weight, based on the total weight of the chewing gum.

The flavorings are present in the inventive chewing gum in an amount of preferably from 0.1 to 2% by weight, particularly preferably from 0.5 to 1% by weight, based on the total weight of the chewing gum.

In a specific embodiment, the chewing gum comprises no components of animal origin, in particular no animal waxes, fats and oils, so that it complies with the requirements for kosher foods.

The inventive chewing gum is available by conventional processes of the prior art, for example by intimate mixting of the components.

Gum bases and chewing gums which comprise the above-described amorphous polyester as polymer base virtually do not stick even to relatively rough surfaces, such as concrete, possess good stability to hydrolysis and are readily biodegraded and broken down by sunlight.

The examples below are intended to illustrate the invention, but without restricting it.

### EXAMPLES

### 1. Preparation of the Polyesters

1.1

746 g of terephthalic acid (4.5 mol), 803 g of adipic acid (5.5 mol), 1272 g (12 mol) of diethylene glycol and 33.7 g (0.37 mol) of glycerol were polyco-condensed by the melt condensation process of Tsai et al., Polymer, 31,1589 (1990). The resultant polyester had a viscosity number of 125 ml/g (determined as described above).

1.2

747 g (4.5 mol) of terephthalic acid, 803 g (5.5 mol) of adipic acid, 1248 g (12 mol) of neopentyl glycol and 33.8 g (0.37 mol) of glycerol were likewise polyco-condensed by the melt condensation process of Tsai et al., Polymer, 31, 1589 (1990). The resultant polyester had a viscosity number of 132 ml/g (determined as described above).

### COMPARATIVE EXAMPLE 1

25 mol % of L-lactide, 25 mol % of D-lactide and 50 mol % of ε-caprolactone were polyco-condensed in accordance with EP-A 0711 506, Example 3. The resultant polyester had a viscosity number of 100 ml/g (determined as described above).

### 2. USE EXAMPLES

The polyesters from Examples 1 to 2 and from Comparative Example 1, and, as Comparative Example 2, a medium-molecular-weight polyisobutene, were tested for their removability, stability to hydrolysis, UV degradability and biodegradability.

2.1 Removability

10 g of a polymer sheet (5×7 cm²) were pressed onto a concrete floor at room temperature and removed by hand. The weight of the polymer removed was determined. The polymer weights measured were rated as follows.

| Weight of polymer removed [g] | Score |
|---|---|
| 8-10 | 1 |
| 6-7.9 | 2 |
| 4-5.9 | 3 |
| 0-3.9 | 4 |

The removability of the polymers from Examples 1 and 2 and Comparative Examples 1 and 2 were rated as scored in the following Table 1.

TABLE 1

| Polymer | Score |
|---|---|
| Example 1 | 1 (9.5 g) |
| Example 2 | 1 (10 g) |
| Comparative Example 1 | 2 (7 g) |
| Comparative Example 2 | 3 (5 g) |

As the table above shows, the inventively used polyesters may be removed considerably more easily from a concrete floor than polymers of the prior art.

2.2 Stability to Hydrolysis

The abovementioned polymers were stored in water at 30° C. and the decrease in viscosity number was measured after 2 and 4 weeks.

The results are listed in Table 2 below.

TABLE 2

| Polymer | VN* (start) | VN* (after 2 weeks) | VN* (after 4 weeks) |
|---|---|---|---|
| Example 1 | 125 | 113 | 108 |
| Example 2 | 132 | 125 | 115 |
| Comparative | 100 | 60 | 35 |
| Example 1 | | | |

*Viscosity number [ml/g]

As shown in the table above, the inventively used polyesters are considerably more stable to hydrolysis than the polyester of the prior art.

2.3 UV Degradability

To determine the UV degradability, a “SUNTEST” rapid illumination unit from the Heraeus company was used. Samples were irradiated at a wavelength of from 300 to 80 nm and a power of 765 W/m². The polymers were illuminated under these conditions for a total of 8 weeks, and the viscosity number of the polymers was determined in each case after one, two, three, four, six and eight weeks. The results are listed in Table 3 below.

TABLE 3

| | Polymer | | | | | | |
|---|---|---|---|---|---|---|---|
| | VN* | VN* | VN* | VN* | VN* | VN* | VN* |
| | (start) | (1 week) | (2 weeks) | (3 weeks) | (4 weeks) | (6 weeks) | (8 weeks) |
| Example 1 | 125 | 124 | 125 | 121 | 122 | 121 | 121 |
| (without | | | | | | | |
| illumination) | | | | | | | |
| Example 1 | 125 | 74 | 59 | 50 | 46 | 35 | 18 |
| Example 2 | 132 | 87 | 67 | 51 | 43 | 36 | 15 |
| Comparative | 100 | 91 | 87 | 84 | 79 | 73 | 69 |
| Example 1 | | | | | | | |

*Viscosity number [ml/g]

As shown in the above table, the inventively used polyesters can be considerably more readily broken down by UV light than the polyester of the prior art.

3.4 Biodegradability

To determine the biodegradability, in each case 30 mg of the amorphous polymer, 2 ml of potassium hydrogen phosphate buffer (20 mM, pH 7.0) and 100 units (1 unit is equivalent to the amount of enzyme which releases one μmol of oleic acid per minute) of lipase from Rhizopus arrhizus from Sigma are placed in 2 ml Eppendorf reaction vessels. The reaction mixture was incubated at 35° C. for 16 hours on a shaker. After the incubation, the reaction mixture was centrifuged and the dissolved organic carbon (DOC) of the supernatant was measured. A Shimadzu DOC analyzer was used for the DOC measurement. In a similar manner, one DOC measurement was made only with buffer and enzyme (enzyme control) and one was made only with buffer and polymer (blank). The results are listed in Table 4 below.

TABLE 4

| Polymer | DOC [mg/l] |
|---|---|
| Example 1 | 567 |
| Example 1 without enzyme | 23 |
| Example 2 | 456 |
| Example 2 without enzyme | 13 |
| Comparative Example 2 | 13 |
| Comparative Example 2 without enzyme | 11 |
| Buffer | 5 |
| Buffer without enzyme | 3 |

As shown in the table above, the inventively used polyesters are very readily biodegraded, whereas the polyisobutene used in conventional gum bases is virtually not decomposed.

3. Gum Bases

The components specified in Table 5 were mixed intimately with one another in the weight ratios specified to form a gum base. For this, the polyester was first heated to 140° C. in a kneader, with kneading, and then the filler, the resin, the fat and the wax were added in succession and the components were kneaded to form a uniform composition.

TABLE 5

| | Gum base no. | | | | | | |
|---|---|---|---|---|---|---|---|
| | 1 | 2 | 3 | 4 | 5 | 6 | 7 |
| Polyester [% by wt.] | 30 | 39.5 | 38 | 43 | 40 | 28 | 35 |
| Filler [% by wt.] | 25 | 25 | 23 | 23 | 22 | 27 | 21 |
| Wax [% by wt.] | 10 | 5 | 5 | 4 | 8 | 5 | 5 |
| Resin [% by wt.] | 20 | 20 | 20 | 10 | 20 | 20 | 20 |
| Fat [% by wt.] | 15 | 10.5 | 14 | 20 | 10 | 20 | 19 |

The polyesters used were the polyesters of Examples 1 and 2. The filler used was limestone. The wax used was microcrystalline wax. The resins used were colophony derivatives from Eastman of the types Picolite C 115 and MBG 429. The fat used was hydrogenated or partially hydrogenated vegetable oil or glycerol monostearate.

1-10. (canceled)

11. A chewing gum comprising a gum base which comprises at least one amorphous polyester containing as repeating units in condensed form
a) at least one aromatic dicarboxylic acid,
b) at least one aliphatic dicarboxylic acid and
c) at least one aliphatic diol which has at least one branching point, a saturated cyclic partial structure and/or at least one ether group,
wherein the molar ratio of a) to b) is from 1:4 to 2:1;
the chewing gum further comprising at least one sweetener and at least one flavoring agent.

12. The chewing gum as claimed in claim 11, wherein the glass transition temperature T_{g} of the polyester is from 0 to −60° C.

13. The chewing gum as claimed in claim 11, wherein the aromatic dicarboxylic acid is at least one selected from the group consisting of terephthalic acid, isophthalic acid and phthalic acid.

14. The chewing gum as claimed in claim 11, wherein the aliphatic dicarboxylic acid is selected from C₄-C₁₂ dicarboxylic acids.

15. The at least one chewing gum as claimed in claim 14, wherein the aliphatic C₄-C₁₂ dicarboxylic acid is at least one selected from the group consisting of succinic acid, glutaric acid, adipic acid, pimelic acid, azelaic acid and sebacic acid.

16. The chewing gum as claimed in claim 11, wherein the aliphatic diol is at least one selected from the group consisting of 2,2-dimethylpropane-1,3-diol, diethylene glycol, triethylene glycol, tetraethylene glycol, pentaethylene glycol, hexaethylene glycol and cyclohexanedimethanol.

17. The chewing gum as claimed in claim 11, wherein the polyester additionally contains, as repeating unit, in condensed form,
d) at least one compound having at least three groups capable of ester formation.

18. The chewing gum as claimed in claim 17, wherein the compound having at least three groups capable of ester formation is at least one selected from the group consisting of tartaric acid, citric acid, malic acid, trimethylolpropane, trimethylolethane, pentaerythritol, polyethertriols, glycerol, trimesic acid, trimellitic acid, pyromellitic acid and hydroxyisophthalic acid.

19. The chewing gum as claimed in claim 17, wherein the polyester contains the component d) in condensed form in an amount of from 0.1 to 5% by weight, based on the total weight of the polyester-forming components.

20. The chewing gum as claimed in claim 11, wherein the gum base further comprises at least one additive selected from the group consisting of resins, waxes, fats and oils.

21. The chewing gum as claimed in claim 11, complying with the requirements for kosher food.

22. A gum base, comprising at least one amorphous polyester which comprises as repeating units in condensed form
a) at least one aromatic dicarboxylic acid,
b) at least one aliphatic dicarboxylic acid and
c) at least one aliphatic diol which has at least one branching point, a saturated cyclic partial structure and/or at least one ether group,
wherein the molar ratio of a) to b) is from 1:4 to 2:1.

23. A method for producing a chewing gum as defined in claim 11, comprising
(i) copolymerizing at least one aromatic dicarboxylic acid or an ester forming derivative thereof, at least one aliphatic dicarboxylic acid or an ester forming derivative. thereof and at least one aliphatic diol which has at least one branching point, a saturated cyclic partial structure and/or at least one ether group; and optionally mixing the thus obtained polyester with at least one further additive to obtain a gum base; and
(ii) intimately mixing the gum base obtained in step (i) with at least one sweetener, at least one flavoring agent and optionally at least one further additive.
